(19) United States
(12) Patent Application Publication
(10) Pub. No.: US 2015/0328754 A1
(43) Pub. Date: Nov. 19, 2015

(54) NAILING MACHINE

(71) Applicant: Basso Industry Corp., Taichung (TW)

(72) Inventors: Liang-Chi HUNG, Taichung (TW); Hung-Da CHEN, Taichung (TW)

(73) Assignee: Basso Industry Corp., Taichung (TW)

(21) Appl. No.: 14/279,107

(22) Filed: May 15, 2014

(51) Int. Cl. B25B 23/04; B23P 19/06

(52) U.S. Cl. CPC B25B 23/045; B23P 19/06

(57) ABSTRACT

A nailing machine 10 includes a machine housing (1) having a gun nozzle (11), a first end (12) formed adjacent to the gun nozzle (11) and a second end (13) away from the gun nozzle (11); a nail track (2) having a third end (21); and a guiding shaft (3) having a fourth end (31) and a fifth end (32); wherein the third end (21) of the nail track (2) and the fourth end (31) of the guiding shaft (3) are connected to the first end (12) of the machine housing (1) with a fixed mechanism (4); the fifth end (32) of the guiding shaft (3) and the second end (13) of the machine housing (1) are connected to the machine housing (1) with a slidable mechanism (5). Therefore, the interferences caused by the jamming of the screwdriver trapped by the nail belt can be prevented.

### BACKGROUND OF THE INVENTION

1. Field of the Invention

The present invention is related to an auxiliary tool for a nail driller, in particular, to a nailing machine.

2. Description of Related Art

It is known that a conventional nailing machine typically uses compressed air or electrical power as its source of power in order to perform the automatic nailing and fastening processes of the screw nails. In such known prior art, the actuation assembly of the nailing machine comprises a screwdriver connected to and actuated together with a nail driller, which is also able to perform the nailing and fastening processes by directly contacting the screwdriver with the end slot of the screw nails.

However, since the screw nails are being installed and assembled continuously in a chain, a nail belt is formed and provided for the use of the nailing machine; nevertheless, during the fastening process of the screwdriver and the screw nails, the screwdriver needs to penetrate through the nail belt as well as to fasten the screw nails into the work piece; therefore, operational interferences caused by the jamming of the screwdriver trapped by the nail belt often occurs, which can easily lead to the bending of the rows of the nails and, consequently, the unfavorable result of misaligned nailing of the screw nails or tangling and twisting of the nail belt.

In view of the above, the inventor seeks to provide a novel solution to overcome the aforementioned drawbacks associated with the known arts along with years of experience and application of theoretical principles in the field.

### SUMMARY OF THE INVENTION

An objective of the present invention is to provide a nailing machine, capable of utilizing a slidable mechanism to actuate together with a screwdriver configured at a later stage and to drive a belt driving assembly to rotate such that the rotation of the belt driving assembly is synchronized with a nail driller in order to allow the nail belt to cooperate with the screwdriver in both loose or tight manners; therefore, the interference caused by the jamming of the screwdriver trapped by the nail belt can be prevented.

To achieve the aforementioned objective, the present invention provides a nailing machine comprising: a machine housing having a gun nozzle, a first end formed adjacent to the gun nozzle and a second end away from the gun nozzle; a nail track having a third end; and a guiding shaft having a fourth end and a fifth end; wherein the third end of the nail track and the fourth end of the guiding shaft are connected to the first end of the machine housing with a fixed mechanism; the fifth end of the guiding shaft and the second end of the machine housing are connected to the machine housing with a slidable mechanism.

The present invention further comprises the following technical effects and merits:

First, the machine housing comprise a moveable assembly, a screwdriver penetrating through the gun nozzle and the moveable assembly and a belt driving assembly installed on the gun nozzle; the moveable assembly is mounted on one end of the gun nozzle to slide relatively thereto; a top portion of the moveable assembly includes a limiter extended thereon; the limiter includes a guiding shaft base portion; the limiter forms the second end; the moveable assembly forms the slidable mechanism; the fifth end of the guiding shaft penetrates through the limiter via the guiding shaft base portion in order to allow the moveable assembly to slide relative to the guiding shaft; the screwdriver and the moveable assembly actuate together to drive the belt driving assembly to rotate. Therefore, the moveable assembly and the screwdriver actuate together and drive the belt driving assembly to rotate in order to allow the operations of the belt driving assembly and the screwdriver to be synchronized with each other for generating clockwise and counterclockwise rotations. With such configuration, the nail belt can be driven to cooperate in both loose and tight manners with the screwdriver correspondingly such that the interferences caused by the jamming of the screwdriver trapped by the nail belt can be prevented.

Second, the moveable assembly comprises a guiding base and a casing; the guiding base includes one end mounted on the gun nozzle to slide relatively thereto and another end penetrating through the casing to be firmly attached thereto; the limiter is formed on the top portion of the casing. With such configuration, the elements of the moveable assembly can be manufactured with ease and assembled with convenience such that the overall assembly of the nailing machine can be facilitated.

Third, the fixed mechanism includes a fixation member; the third end of the nail track is secured onto the first positioning plate; the first end of the machine housing is secured on the second positioning plate; the fourth end of the guiding shaft is secured on the main body. With such configuration, the elements of the fixed mechanism can be manufactured with ease and assembled with convenience in addition to that the nail track requires no extensive reworks, reducing its cost and improving the smoothness of the nail track; therefore, the overall cost of the nailing machine is reduced as well.

Fourth, the fixation member includes a main body and a first positioning plate and a second positioning plate extended from two ends of the main body toward an identical direction; the main body includes a pair of L-shaped locking members opposite from each other and extended toward a direction away from the first positioning plate and the second positioning plate; a locking slot is formed between the pair of L-shaped locking members. With such configuration, the nail belt deviates away from the nail track can be guided by the locking slot to the front of the gun nozzle such that the nails on the nail belt can be stably configured to correspond with the screwdriver.

### BRIEF DESCRIPTION OF DRAWING

FIG. 1 is an exploded view of the nailing machine of the present invention;

FIG. 2 is a perspective view showing an assembly of the nailing machine of the present invention;

FIG. 3 is another perspective view showing an assembly of the nailing machine of the present invention;

FIG. 4 is an illustration showing a state of use of the nailing machine of the present invention; and

FIG. 5 is an illustration showing another state of use of the nailing machine of the present invention.

### DETAILED DESCRIPTION OF THE INVENTION

The following provides detailed description of embodiments of the present invention along with the accompanied drawings. It can, however, be understood that the accompanied drawings are provided for illustrative purposes only and shall not be treated as limitations to the present invention.

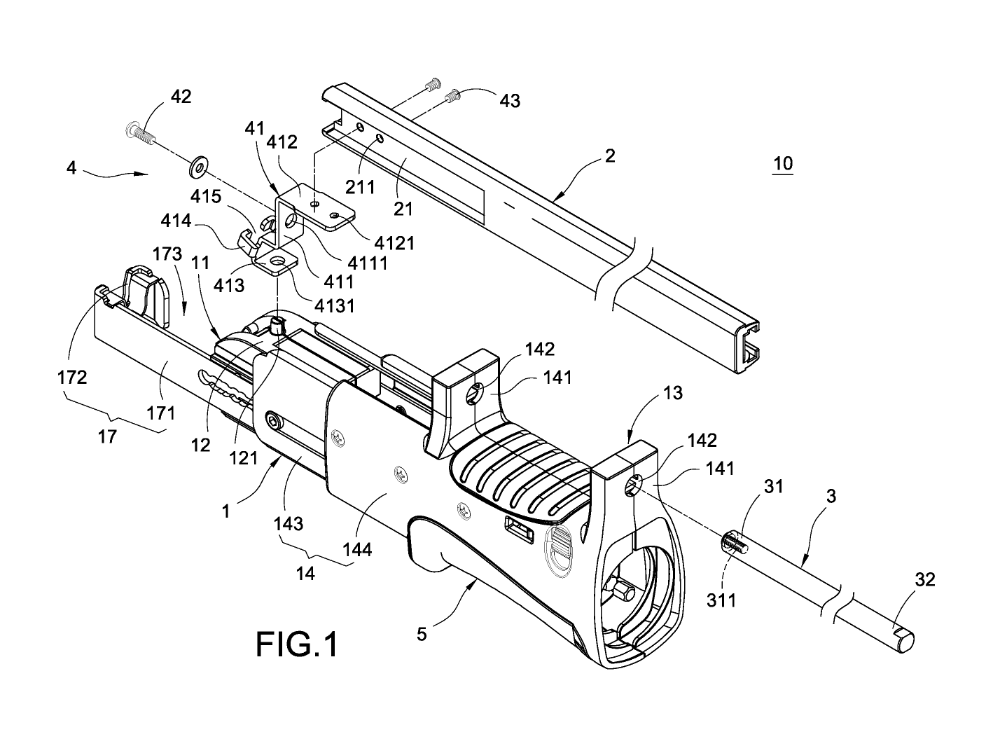

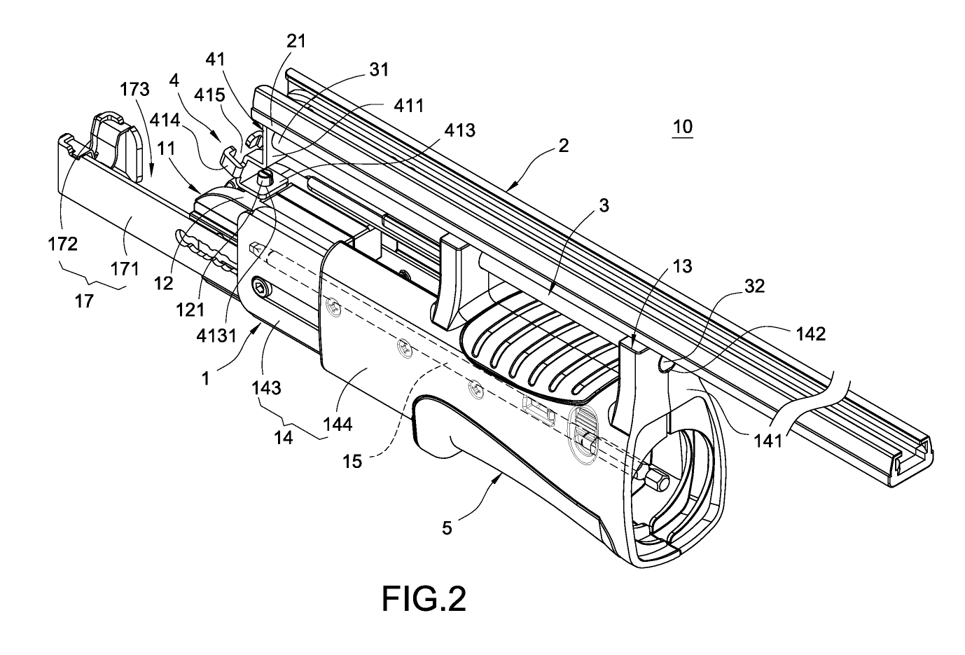

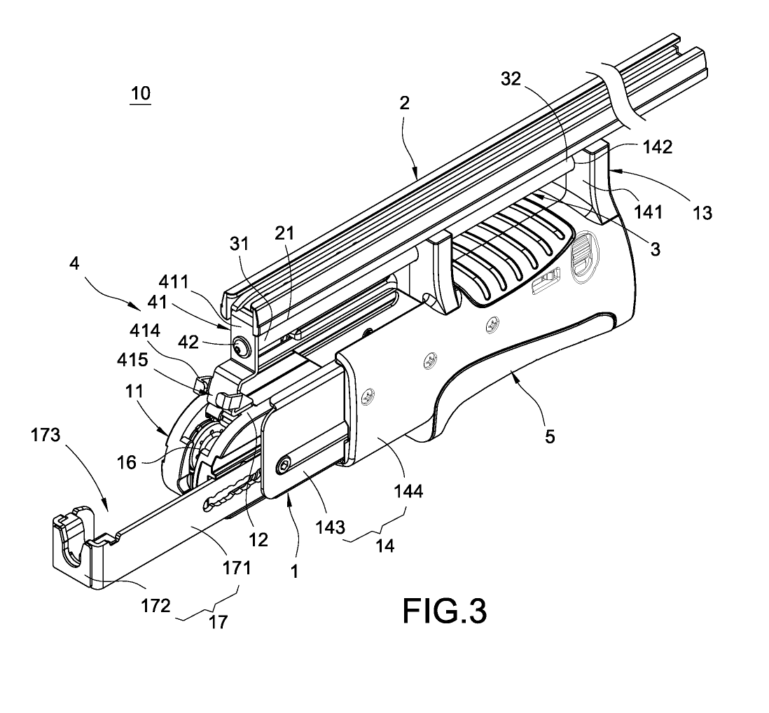

Please refer to FIG. 1 to FIG. 3. The present invention provides a nailing machine, and the nailing machine 10 mainly comprises a machine housing 1, a nail track 2 and a guiding shaft 3.

The machine housing 1 includes a gun nozzle 11, a first end 12 formed adjacent to the gun nozzle 11 and a second end 13 away from the gun nozzle 11. In addition, the machine housing 1 comprises a moveable assembly 14, a screwdriver 15 penetrating the gun nozzle 11 and the moveable assembly 14 and a belt driving assembly 16 mounted on the gun nozzle 11.

The moveable assembly 14 is mounted on one end of the gun nozzle 11 to slide relatively thereto; the moveable assembly 14 includes at least one limiter 141 extended from a top portion thereof; each limiter 141 includes a guiding shaft base portion 142; each limiter 141 forms the second end 13; the moveable assembly 14 forms the slidable mechanism 5; the fifth end 32 of the guiding shaft 3 penetrates through the limiters 141 via the guiding shaft base portion 142 in order to allow the moveable assembly 14 to slide relative to the guiding shaft 3. The following provides a further description in detail. The moveable assembly 14 comprises a guiding base 143 and a casing 144; the guiding base 143 includes one end mounted on the gun nozzle 11 to slide relatively thereto and another end penetrating through the casing 144 to secure thereon; the limiters 141 are formed to extend from a top portion of the casing 144. Furthermore, the screwdriver 15 and the moveable assembly 14 actuate together to drive the belt driving assembly 16 to rotate; wherein, according to a preferred embodiment, the guiding shaft base portion 142 is a through hole but is not limited to such form only, which can be modified based on the actual needs.

In addition, the machine housing 1 further comprises a safety member 17. The safety member includes an adjustable limiting rib 171 and a push locking member 172. The adjustable limiting rib 171 includes one end secured onto the gun nozzle 11 away from one end of the slidable mechanism 5 and another end connected to the push locking member 172. A cartridge slot 173 is formed among the gun nozzle 11, the adjustable limiting rib 171 and the push locking member 172.

The nail track 2 is a track slot formed on an elongated shaft. The nail track 2 includes a third end 21. The guiding shaft 3 is a column shaft; the guiding shaft 3 includes a fourth end 31 and a fifth end 32.

In this embodiment, the third end 21 of the nail track 2 and the fourth end 31 of the guiding shaft 3 are connected to the first end 12 of the machine housing 1 with a fixed mechanism 4. The fifth end 32 of the guiding shaft 3 and the second end 13 of the machine housing 1 are connected to the machine housing 1 with a slidable mechanism 5.

Furthermore, with respect to the connecting method adapted by the third end 21 of the nail track 2 and the fourth end 31 of the guiding shaft 3 with the first end 12 of the machine housing 1, as shown in FIG. 1, the fixed mechanism 4 comprises a fixation member 41, a first fastening member 42 and a second fastening member 43. The fixation member 41 includes a main body 411 and a first positioning plate 412 and a second positioning plate 413 extended from two ends of the main body 411 toward an identical direction. The main body 411 includes a first through hole 4111; the first positioning plate 412 includes a second through hole 4121; the second positioning plate 413 includes a third through hole 4131; the fourth end 31 of the guiding shaft 3 includes a hole 311; the first fastening member 42 correspondingly penetrates through the hole 311 and the first through hole 4111 to be secured thereon; the third end 21 of the nail track 2 includes a perforation 211; the second fastening member 43 correspondingly penetrates through the perforation 211 and the second through hole 4121 to be secured thereon; the first end 12 of the machine housing 1 includes a protruding column 121 extended therefrom; the protruding column 121 penetrates through the third through hole 4131 to be positioned thereon.

In addition, the main body 411 includes a pair of L-shaped locking members 414 opposite from each other and extended toward a direction away from the first positioning plate 412 and the second positioning plate 413. A locking slot 415 is formed between the pair of L-shaped locking members 414.

Alternatively, the connection method adapted by the third end 21 of the nail track 2 and the fourth end 31 of the guiding shaft 3 with the first end 12 of the machine housing 1 can also modified as the following. The fixed mechanism 4 includes a fixation member 41; the fixation member 41 includes a main body 411 and a first positioning plate 412 and a second positioning plate 413 extended from two ends of the main body 411 toward an identical direction. The third end 21 of the nail track 2 is soldered onto the first positioning plate 412; the first end 12 of the machine housing 1 is soldered onto the second positioning plate 413; the fourth end of the guiding shaft 3 is soldered onto the main body 411.

The assembly of the nailing machine 10 utilizes the machine housing 1 having the gun nozzle 11, a first end 12 formed adjacent to the gun nozzle 11 and a second end 13 away from the gun nozzle 11; the nail track 2 having a third end 21; the guiding shaft 3 having the fourth end 31 and the fifth end 32; wherein the third end 21 of the nail track 2 and the fourth end 31 of the guiding shaft are connected to the first end 12 of the machine housing 1 with a fixed mechanism 4; the fifth end 32 of the guiding shaft 3 penetrates through the guiding shaft base portion 142 of the second end 13 of the machine housing 1 as well as penetrates through the limiters 141 in order to allow the limiters 141 to slide relative to the guiding shaft 3, which means that the first end 12 forms a connection with the machine housing 1 and the second end 13 forms a slidable mechanism 5 for connecting to the machine housing 1.

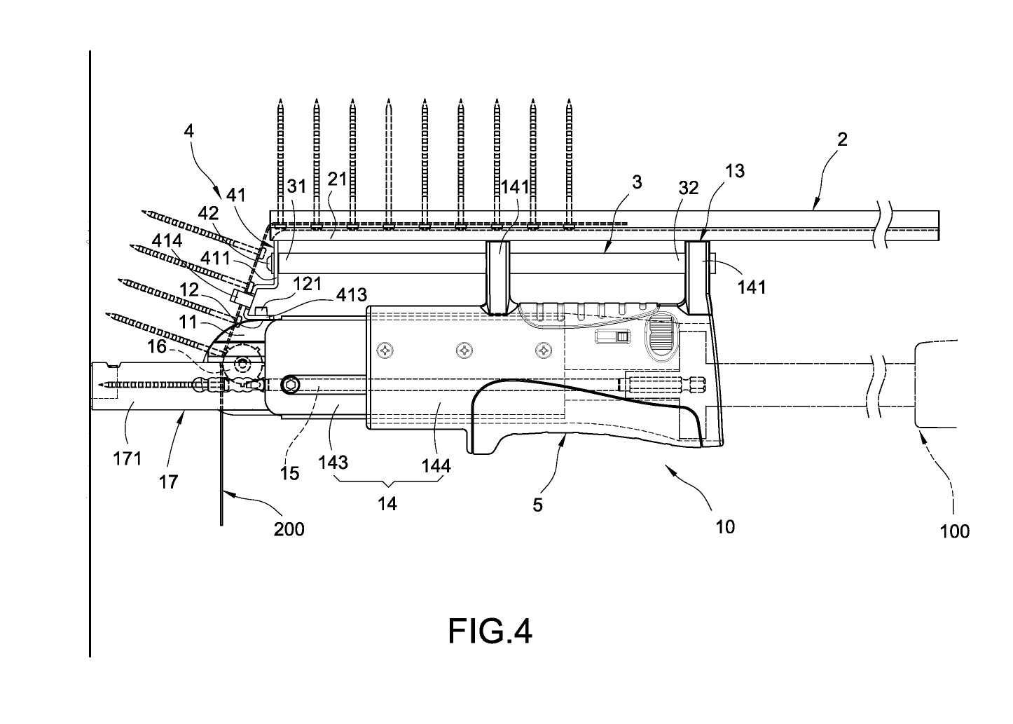

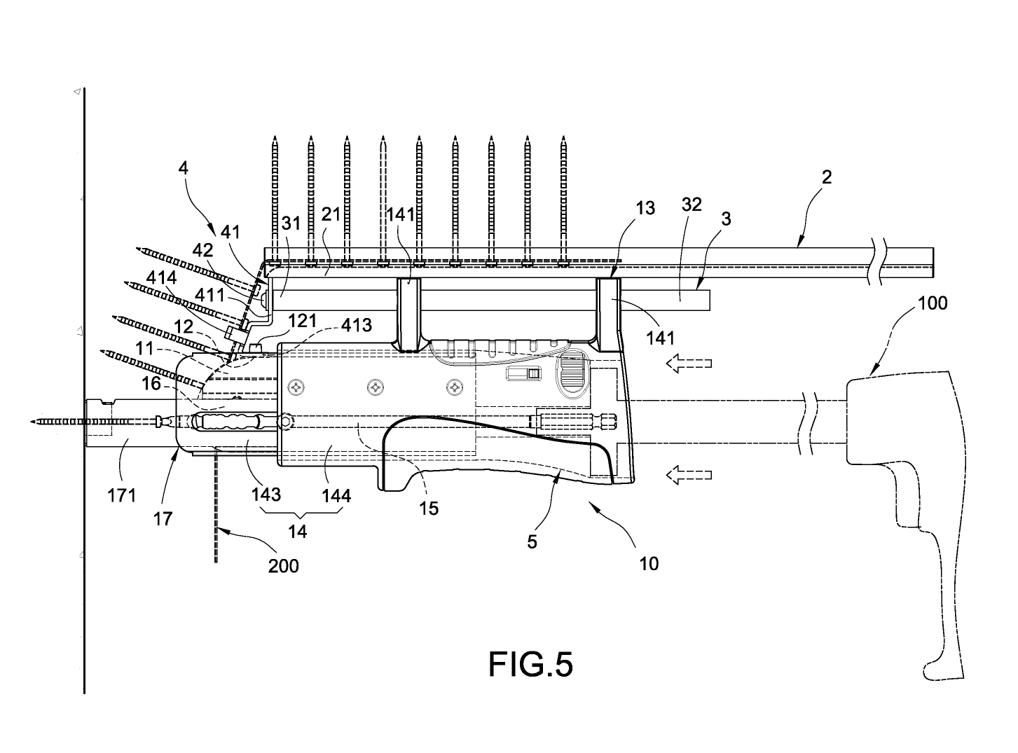

Please refer to FIG. 4 to FIG. 5 showing the states of uses of the nailing machine 10 of the present invention. As shown in the figures, the fifth end 32 of the guiding shaft 3 and the second end 13 of the machine housing 1 are connected to the machine housing 1 with the slidable mechanism 5 such that the interferences caused by the jamming of the screwdriver 15 trapped by the nail belt 200 can be prevented.

The following provides further details. The machine housing 1 comprises the moveable assembly 14, the screwdriver 15 penetrating through the gun nozzle 11 and the moveable assembly 14 and a belt driving assembly 16 installed at the gun nozzle 11. The moveable assembly 14 is mounted on one end of the gun nozzle 11 to slide relatively thereto; the top portion of the moveable assembly 14 includes the limiter 141 extended therefrom; the limiter 141 includes the guiding shaft base portion 142; the limiter 141 forms the second end 13; the moveable assembly 14 forms the slidable mechanism 5; the fifth end 32 of the guiding shaft 3 penetrates through the limiter 141 via the guiding shaft base portion 142; with such configuration, the moveable assembly 14 is able to slide relative to the guiding shaft 3; the screwdriver 15 and the moveable assembly 14 actuate together to drive the belt driving assembly 16 to rotate.

The rear end of the screwdriver 15 is connected to a nail driller 100 in order to allow the nail driller 100 to drive the screwdriver 15 for operations. The nail belt 200 is installed on the nail track 2 and is configured to correspond with the gun nozzle 11 at one end thereof. Since the moveably assembly 14 and the screwdriver 15 actuate together to drive the belt driving assembly 16 to rotate, the operations of the belt driving assembly 16 and the screwdriver 15 can be synchronized to generate clockwise and counterclockwise rotations in order to drive the nail belt 200 to cooperate with the screwdriver 15 in both loose and tight manners correspondingly such that the interferences caused by the jamming of the screwdriver 15 trapped by the nail belt 200 can be prevented.

In addition, the moveable assembly 14 comprises the guiding base 143 and the casing 144. The guiding base 143 includes one end mounted on the gun nozzle 11 to slide relatively thereto and another end penetrating through the casing 144 to be secured thereon. The limiter 141 is formed to extend from the top portion of the casing 144. With such configuration, the elements of the moveable assembly 14 can be manufactured with ease and assembled with convenience such that the overall assembly of the nailing machine 10 is facilitated.

Furthermore, the fixed mechanism 4 includes the fixation member 41; the third end 21 of the nail track 2 is secured onto the first positioning plate 412; the first end 12 of the machine housing 1 is secured on the second positioning plate 413; the fourth end 31 of the guiding shaft 3 is secured on the main body 411. With such configuration, the elements of the fixed mechanism 4 can be manufactured with ease and assembled with convenience in addition to that the nail track 2 requires no extensive reworks, reducing its cost and improving the smoothness of the nail track 2; therefore, the overall cost of the nailing machine 10 is too reduced.

Moreover, the fixation member 41 include the main body 411 and the first positioning plate 412 and the second positioning plate 413 extended from two ends of the main body 411 toward an identical direction; the main body 411 includes a pair of L-shaped locking members 414 opposite from each other and extended toward a direction away from the first positioning plate 412 and the second positioning plate 413; a locking slot 415 is formed between the pair of L-shaped locking members 414. With such configuration, the nail belt 200 deviates away from the nail track 2 can be guided by the locking slot 415 to the front of the gun nozzle 11 such that the nails on the nail belt 200 can be stably configured to correspond with the screwdriver 15.

Additionally, the machine housing 1 further comprises the safety member 17. The safety member 17 includes the adjustable limiting rib 171 and the push locking member 172. A cartridge slot 173 is formed among the gun nozzle 11, the adjustable limiting rib 171 and the push locking member 172. With such configuration, the adjustable limiting rib 171 is able to adjust the distance of the cartridge slot 173 in order to provide the accommodating space for receiving the nails on the nail belt 200.

In view of the above, the nailing machine of the present invention is not seen in any similar products or has been put to use publically, which is certainly of industrial applicability, novelty and inventive step as well as complying with the requirement of patentability. The present invention is, therefore, legitimately applied for the grant of a patent.

What is claimed is:

1. A nailing machine (10), comprising:
a machine housing (1) having a gun nozzle (11), a first end (12) formed adjacent to the gun nozzle (11) and a second end (13) away from the gun nozzle (11);
a nail track (2) having a third end (21); and
a guiding shaft (3) having a fourth end (31) and a fifth end (32);
wherein the third end (21) of the nail track (2) and the fourth end (31) of the guiding shaft (3) are connected to the first end (12) of the machine housing (1) with a fixed mechanism (4); the fifth end (32) of the guiding shaft (3) and the second end (13) of the machine housing (1) are connected to the machine housing (1) with a slidable mechanism (5).

2. The nailing machine according to claim 1, wherein the machine housing (1) comprises a moveable assembly (14); the moveable assembly (14) is mounted on one end of the gun nozzle (11) to slide relatively thereto; the moveable assembly (14) includes at least one limiter (141) formed adjacent to the nail track (2); the at least one limiter (141) includes a guiding shaft base portion (142); the at least one limiter (141) forms the second end (13), the fifth end (32) of the guiding shaft (3) penetrates through the at least one limiter (141) via the guiding shaft base portion (142) in order to allow the moveable assembly (14) to slide relative to the guiding shaft (3).

3. The nailing machine according to claim 2, wherein the moveable assembly (14) comprises a guiding base (143) and a casing (144); the guiding base (143) includes one end mounted on the gun nozzle (11) to slide relatively thereto and another end penetrating through the casing (144) to be secured thereon; the at least one limiter (141) is formed to extend from a top portion of the casing (144).

4. The nailing machine according to claim 2, wherein the machine housing (1) comprises a screwdriver (15) penetrating through the gun nozzle (11) and the moveable assembly (14) and a belt driving assembly (16) installed on the gun nozzle (11); the screwdriver (15) and the moveable assembly (14) actuate together to drive the belt driving assembling (16) to rotate.

5. The nailing machine according to claim 1, wherein the fixed mechanism (14) includes a fixation member (41); the fixation member (41) includes a main body (411) and a first positioning plate (412) and a second positioning plat (413) respectively extended from two ends of the main body (411) toward an identical direction; the third end (21) of the nail track (2) is soldered onto the first positioning plate (412); the first end (12) of the machine housing (1) is soldered onto the second positioning plate (413); the fourth end (31) of the guiding shaft (3) is soldered onto the main body (411).

6. The nailing machine according to claim 5, wherein the main body (411) includes a pair of L-shaped locking members (414) opposite from each other and extended toward a direction away from the first positioning plate (412) and the second positioning plate (413); a locking slot (415) is formed between the pair of L-shaped locking members (414).

7. The nailing machine according to claim 1, wherein the fixed mechanism (4) comprises a fixation member (41), a first fastening member (42) and a second fastening member (43); the fixation member (41) includes a main body (411) and a first positioning plate (412) and a second positioning plate (413) respectively extended from two ends of the main body (411) toward an identical direction; the main body (411) includes a first through hole (4111); the first positioning plate (412) includes a second through hole (4121); the second positioning plate (413) includes a third through hole (4131); the fourth end (31) of the guiding shaft (3) includes a hole (311); the first fastening member (32) correspondingly penetrates through the hole (311) and the first through hole (4111) to be secured thereon; the third end (21) of the nail track (2) includes a perforation (211); the second fastening member (43) correspondingly penetrates through the perforation (211) and the second through hole (4121) to be secured thereon; the first end (12) of the machine housing (1) includes a protruding column (121) extended therefrom; the protruding column (121) penetrates through the third through hole (4131) to be secured thereon.

8. The nailing machine according to claim 7, wherein the main body (411) includes a pair of L-shaped locking members (414) opposite from each other and extended toward a direction away from the first positioning plate (412) and the second positioning plate (413); a locking slot (415) is formed between the pair of L-shaped locking members (414).

9. The nailing machine according to claim 1, wherein the machine housing (1) further comprises a safety member (17); the safety member (17) includes an adjustable limiting rib (171) and a push locking member (172); the adjustable limiting rib (171) includes one end secured onto the gun nozzle (11) away from one end of the slidable mechanism (5) and another end connected to the push locking member (172); a cartridge slot (173) is formed among the gun nozzle (11), the adjustable limiting rib (171) and the push locking member (172).
